(19) United States
(12) Patent Application Publication
(10) Pub. No.: US 2013/0225276 A1
(43) Pub. Date: Aug. 29, 2013

(54) CARD GAMES

(71) Applicant: Chi Fat Au-Yeung, Edgbaston (GB)

(72) Inventor: Chi Fat Au-Yeung, Edgbaston (GB)

(21) Appl. No.: 13/879,088

(22) PCT Filed: Nov. 9, 2011
(86) PCT No.: PCT/GB2011/001571

§ 371 Date: Apr. 12, 2013

(30) Foreign Application Priority Data
Nov. 15, 2010 (GB) 1019260.7

(51) Int. Cl. A63F 1/00; G07F 17/32

(52) U.S. Cl. CPC A63F 1/00; G07F 17/3293
USPC 463/25; 273/292

(57) ABSTRACT

A method of playing a card game includes the steps of: a player placing one or more contrast bets, with each contrast bet relating to one of three possible criteria, the color of the cards (black/red), whether the cards are odd/even and whether the cards are high/low; dealing two or more cards from a pack of cards; and the player winning the contrast bet on a selected criteria, of at least one card fulfills one of the selected criteria and at least one other card fulfills the opposite selected criteria.

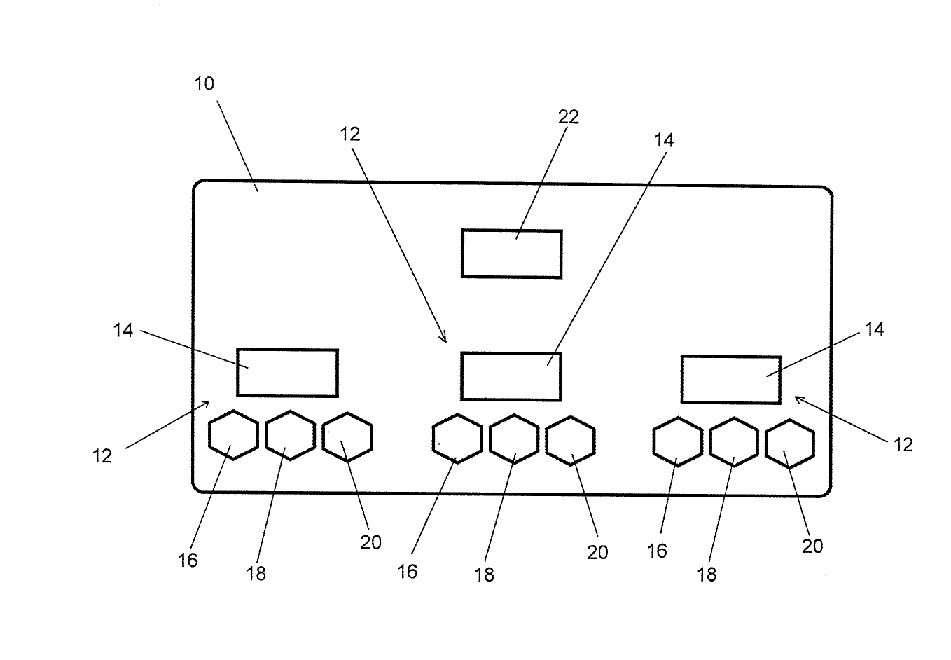

This application is a National Stage completion of PCT/GB2011/001571 filed Nov. 9, 2011, which claims priority from British patent application serial no. 1019260.7 filed Nov. 15, 2010.

### FIELD OF THE INVENTION

The present invention relates to card games and in particular a method of playing a card game which may be played by one or more Players for gaming purposes or as a family or fun game.

### SUMMARY OF THE INVENTION

In this specification, where the context so admits, reference to the male shall include the female, use of the singular shall include the plural and vice versa and the following expressions shall bear the following meanings that is to say:

‘the House’ shall mean ‘a Casino or other Gaming Institution’

‘pre-designated cards’ shall mean ‘the cards selected by the Dealer to comprise the target-hand in any particular deal’

‘main game’ shall mean ‘a stand-alone game’

‘side bet’ shall mean ‘a game that is subsidiary, optional or supplemental to a main game’

‘Contrast event’ shall mean ‘in any group of two or more pre-designated cards one of three combinations shall occur namely (I) one or more cards Red, the other(s) Black, (ii) one or more cards High, the other(s) Low, or (iii) or one or more cards Odd, the other(s) Even.’

According to one aspect of the present invention a method of playing a card game comprises;

a player placing one or more contrast bets, each contrast bet relating to one of three possible criteria, the color of the cards (Black/Red), whether the cards are Odd/Even and whether the cards are High/Low;

dealing two or more cards from a pack of cards,

the player winning the contrast bet on a selected criteria, if at least one card fulfills one of the selected criteria and at least one other card fulfills the opposite selected criteria.

According to a preferred embodiment two or more cards are dealt;

the player, before the cards are revealed placing one or more bets on the criteria Black/Red, Odd/Even or High/Low;

the player winning a contrast bet placed in respect of the criteria Black/Red, if at least one of the cards is Black and at least one of the cards is Red;

the player winning a contrast bet placed in respect of the criteria Odd/Even, if at least one the cards is odd and at least one of the cards is even;

the player winning a contrast bet placed in respect of the criteria High/Low, if at least one of the cards is High and at least one of the cards is Low.

According to a further embodiment of the invention;

one or more cards are dealt to a player and a community card is dealt, the player before the cards are revealed placing one or more bets on the criteria Black/Red, Odd/Even or High/Low;

the player winning a contrast bet placed on the criteria High/Low if at least one of the cards dealt to the player is high while the community card is low, or at least one of the cards dealt to the player is low while the community card is high;

the player winning a contrast bet placed on the criteria Odd/Even if at least one of the cards dealt to the player is Odd while the community card is Even, or at least one cards dealt to the player is Even while the community card is Odd;

the player winning a contrast bet placed on the criteria Black/Red if at least one of the cards dealt to the player is Red while the community card is Black, or at least one of the cards dealt to the player is Black while the community card is Red.

The odds at which winning bets are paid may vary depending on additional criteria, for example the with:

Bet on the criteria High/Low the odds may be increased:

when the player is dealt two or more cards, if two or more of the player cards are of the same rank;

when the players card or cards and community card are of the same suit (i.e. all harts, diamonds, clubs or spades) or the same color (i.e. all red or all black);

Bet on the criteria Odd/Even the odds may be increased:

when the player is dealt two or more cards, if two or more of the player cards are of the same rank;

when the players card or cards and community card are of the same suit (i.e. all harts, diamonds, clubs or spades) or color (i.e. all red or all black);

Bet on the criteria Black/Red the odds may be increased:

when the player is dealt two or more cards, if two or more of the player cards are of the same suit (i.e. all harts, all diamonds, all clubs or all spades);

when the players card or cards and the community card are of the same rank or when the players cards are of the same rank;

The odds paid out on the bets may also be increased where multiple winning bets on different criteria are placed by the player in the same game.

The game of the present invention may be played as a subsidiary or side bet to a main game, for example Blackjack, Baccarat, Punto Banco or Poker. When played as a subsidiary to a main game, a community card may be dealt in addition the normal cards of the main game or may be a specified card of the cards dealt to constitute, for example the dealers hand of the main game.

### BRIEF DESCRIPTION OF THE DRAWINGS

The game is now described, by way of example only, with reference to the sole Figure which illustrates a playing area or cloth for playing an embodiment of the present invention.

### DETAILED DESCRIPTION OF THE PREFERRED EMBODIMENTS

As illustrated in the sole figure, a playing area or cloth 10 is divided into a number of player areas 12. Each player area having an box 14 into which one or more cards may be dealt to a player, and betting areas 16, 18 and 20 in which the player may place bets on the criteria High/Low, the criteria Odd/Even and/or the criteria Black/Red, respectively. The playing area or cloth 10 also has a box 22 into which on or more common cards or dealer's cards may be dealt.

### EXAMPLE 1

In accordance with one embodiment of the game a Player make upto three bets by placing money or chips in bet area 16 “Contrast High-Low” (High cards 10-A and Low cards 2-9), bet area 18 “Contrast Odd-Even” (Odd cards A, 3,5,7,9 and Even cards 2,4,6,8,10, Jack,Queen,King) and/or bet area 20 “Contrast Color” (Red/Black).

One card is then dealt to box 14 of the player's area 12 and a community card is dealt to box 22, from a multi-deck pack of conventional playing cards. If the Player has placed a bet in area 16, the player wins if his card and the community card are contrasted one High card and one Low card, e.g. one the players card is High (10-A) and the community card is low (2-9) or vice versa. Winning bets are paid out at odds of 1:1.

A second card is then dealt to box 14 of the Players area 12. If the player has placed a bet in bet area 18, the player wins if his two cards and the community card are contrasted one Odd and the other Even, e.g. both of the players cards are Odd (A,3,5,7,9) and the community card is even (2,4,6,8,10,Jack,Queen,King), or vice versa. Winning bets are paid out at odds of 1:1

If the player has placed a bet in bet area 20, the player wins if his two cards are the same color and contrast with the community card, e.g. both Player's cards are Red (Heart and or Diamond) and the community card is black (Club or Spade), or vice versa. Winning bets are paid out at odds in accordance with the following Pay-table:

Contrast Red-Black Pay-table

| | Examples | | |
|---|---|---|---|
| Hand | Players | Community | Odds |
| Contrast Trips | A [symbol] and A [symbol] (Black) | A♡ (Red) | 50 to 1 |
| (three of a kind) | 6♡ and 6♦ (Red) | 6 [symbol] (Black) | |
| Contrast Suited- | 10♡ and 10♡ (Red) | A [symbol] (Black) | 11 to 1 |
| Pair | K [symbol] and K [symbol] (Black) | 3♦ (Red) | |
| Contrast Color- | 3 [symbol] and 3 [symbol] (Black) | J♡ (Red) | 9 to1 |
| Pair | Q♡ and Q♦ (Red) | K [symbol] (Black) | |
| Contrast | A♡ and 3♦ (Red) | 8 [symbol] (Black) | 2 to 1 |
| | 9 [symbol] and 7 [symbol] (Black) | 7♡ (Red) | |
| Other | 4♦ and 6 [symbol] | 6♡ | Lose |
| | A♡ and A [symbol] | Q♡ | |
| | 10♦ and 10 [symbol] | 10♡ | |
| | 6♦ and 6♡ | 5♦ | |

### EXAMPLE 2

In accordance with an alternative embodiment of the game two cards are dealt to each player participating in the game. Each player may then place one or more bets separately on the criteria Black/Red; Odd/Even and High/Low.

The Player wins a bet placed on the criteria Black/Red if one of the dealt cards is Black (Clubs or Spades) and the other card is Red (Harts or Diamonds).

The Player wins a bet placed on the criteria Odd/Even if one of the dealt cards is Odd (A,3,5,7,9) and the other card is Even (2,4,6,8,10,Jack,Queen,King).

The Player wins a bet placed on the criteria High/Low if one of the dealt cards is High (9 to A) and the other card is Low (2 to 8).

Successful wagers will be paid out at odds in accordance with the following pay-table.

Pay-table

| Bet | Hand | Examples | Odds |
|---|---|---|---|
| Black/Red | Contrast - Pair | 3♡ and 3 [symbol] | 4:1 |
| | | 10 [symbol] and 10♦ | |
| | Contrast - Straight | A [symbol] and 2♦ | 2:1 |
| | | 7♡ and 8 [symbol] | |
| | | J♦ and Q [symbol] | |
| | Contrast | 2 [symbol] and A♡ | 1:2 |
| | | Q♦ and 7 [symbol] | |
| | Other | 8 [symbol] and 8 [symbol] | Lose |
| | | K♦ and 7♡ | |
| High/Low | Contrast - Suited | 4 [symbol] and 10 [symbol] | 3:2 |
| | | A♡ and 8♡ | |
| | Contrast - Same | 2♦ and Q♡ | 1:1 |
| | color | K [symbol] and 7 [symbol] | |
| | Contrast | 3 [symbol] and J♦ | 1:2 |
| | | K♡ and 6 [symbol] | |
| | Other | K [symbol] and Q [symbol] | Lose |
| | | 5♡ and 7 [symbol] | |
| | | 6♡ and 6♦ | |
| Odd/Even | Contrast - Suited | 5♦ and 8♦ | 3:2 |
| | | A [symbol] and Q [symbol] | |
| | Contrast - Same | 4 [symbol] and 5 [symbol] | 1:1 |
| | color | 9♡ and J♦ | |
| | Contrast | 3 [symbol] and 6♡ | 1:2 |
| | | A♦ and 10 [symbol] | |
| | Other | 2 [symbol] and 8 [symbol] | Lose |
| | | 5♡ and 3♦ | |
| | | J [symbol] and Q♡ | |
| | | 7 [symbol] and 7 [symbol] | |

In a modification of the embodiment described in example 2, the player may be dealt three or more cards, the player requiring at least one card to contrast, i.e. Black and Red; Odd and Even; or High and Low, with at least one other card, to win a bet in respect of that contrast. Additionally, it may be specified that predetermined cards dealt to the player must contrast, for example the first and third cards must contrast or that the first and second cards must contrast with the third card.

The cards used to decide the contrast bet may be individual cards dealt to the player, a combination of individual cards and cards dealt to a dealer's hand or community cards or may be cards dealt to a dealer's hand or to a community hand, which are common to all the players.

The embodiments of the invention described above, or variations thereof may be played as a stand-alone or as a subsidiary or side-bet game to a main game, for example any Poker based game, Blackjack, Baccarat or Punto Banco. When played as a subsidiary or side bet the cards used to decide the outcome of a contrast bet, may be cards dealt to the player or a combination of cards dealt to the Player and pre-designated cards of a hand dealt to a dealer in respect of the main game. For example when played in conjunction with Blackjack, the subsidiary or side-bet game may be decided on the Player's first two Blackjack cards, one card having to contrast with the other, as described above.

Alternatively, for a three card preliminary or side bet game, the Player's first two Blackjack cards and the Dealer's first card may be used, the players cards for example having the be the same and contrasting with the dealers card, in respect to the selected contrast.

A four card preliminary or side bet game may be played with the Player's first two Blackjack cards and the Dealer's first two cards, the player's two cards having to be similar, for example both Red, both Odd or both High and contrasting with both of the dealers cards.

When the game is played as a subsidiary or side-bet game to a five card

Poker game, all five of the Player's cards may be used to determine the outcome of subsidiary or side-bet game, for example two cards of the Player's hand must be similar and contrast and the other three cards, for example two cards must be Red and the other three Black, two cards must be Even and three cards Odd , two cards High and three cards Low or vice versa.

Alternatively the subsidiary or side-bet game may be decided on cards dealt to the Player for the main game together with one or more cards dealt specifically for the subsidiary or side-bet game and superfluous to the main game, for example a subsidiary or side-bet game corresponding to that described in Example 1 above may be played with the first two cards dealt to a players Blackjack hand and a community card dealt specifically for the purpose if the subsidiary or side-bet game in addition to the cards dealt for the purposes of the Blackjack game.

The game in accordance with the present invention may be played with any number of cards. The game may be played with any number of decks of standard playing cards. Alternative the game may be played with standard decks from which one or more cards have been added or removed prior to the dealing of any hand. Any such card or cards may be blank, of a color or colors other than red and black or characterized as a bug or joker or contain a non-standard symbol or symbols and/or may bear such properties as may be pre-designated at or prior to the dealing of any hand.

In an alternative embodiment the game or any variation thereof may be played in electronic form, by remote betting, on the world wide web, on the internet, on a local area network or remote network or by way of scratch-card or lottery or as a family or fun game.

Various modifications may be made without departing from the invention. For example the definition of High and Low or Odd and Even in the embodiments described above may be varied. For example in Example 1, High is defined as (10 to A) and Low as (2 to 9), while in Example 2 High is (9 to A) and Low is (2 to 8), as an alternative High may be defined as (8 to K) and low as (A to 7). Also as described above Odd is defined as (A, 3, 5, 7, 9) and Even as (2, 4, 6, 8, 10, J, Q, K), alternatively Odd may be defined as (A, 3, 5, 7, 9, J, K) and Even as (2, 4, 6, 8, 10, Q).

1-10. (canceled)

11. A method of playing a card game, the method comprising the steps of:
a player placing one or more contrast bets, each contrast bet relating to one of three possible criteria, a black/red color criteria of the cards, whether the cards are odd/even criteria and whether the cards are high/low criteria,
dealing two or more cards from a pack of cards, and
the player winning the contrast bet on a selected criteria, if at least one card fulfills one of the selected criteria and at least one other card fulfills the opposite selected criteria.

12. The method according to claim 11, further comprising the step of dealing two or more cards to a player,
the player winning a contrast bet placed in respect of the black/red color criteria, if at least one of the cards is black and at least one of the cards is red;
the player winning a contrast bet placed in respect of the odd/even criteria, if at least one the cards is odd and at least one of the cards is even;
the player winning a contrast bet placed in respect of the high/low criteria, if at least one of the cards is high and at least one of the cards is low.

13. The method according to claim 11, further comprising the step of dealing one or more cards to a player and dealing a community card,
the player winning a contrast bet placed on the high/low criteria if at least one of the cards dealt to the player is high while the community card is low, or at least one of the cards dealt to the player is low while the community card is high;
the player winning a contrast bet placed on the odd/even criteria if at least one of the cards dealt to the player is odd while the community card is even, or at least one cards dealt to the player is even while the community card is odd;
the player winning a contrast bet placed on the black/red color criteria if at least one of the cards dealt to the player is red while the community card is black, or at least one of the cards dealt to the player is black while the community card is red.

14. The method according to claim 13, further comprising the step of dealing two or more cards to the player, all of the players cards being of the same of the selected criteria and the selected criteria of a community card contrasting with that of the player's cards in order to win the contrast bet.

15. The method according to claim 11, further comprising the step of dealing cards for a main game and using one or more of the cards from the main game to decide the outcome of the contrast bet.

16. The method according to claim 15, further comprising the step of using one of blackjack, baccarat, punto banco or poker as the main game.

17. The method according to claim 15, further comprising the step of using, as the cards which decide the outcome of the contrast bet, two or more cards dealt to form, at least in part, a hand for the player, a dealer hand and/or community cards for the main game.

18. The method according to claim 15, further comprising the step of using, as the cards which decide the outcome of the contrast bet, at least one community card dealt in addition to the cards required to play the main game.

19. The method according to claim 11, further comprising the step of playing the game one of live and via a remote game electronic format, on the world wide web, on the internet, on a local area or remote network, on a mobile phone or as a scratch card or lottery.
